(19) United States
(12) Patent Application Publication
(10) Pub. No.: US 2013/0246937 A1
(43) Pub. Date: Sep. 19, 2013

(54) METHOD FOR MANAGING SINK DEVICE, SOURCE DEVICE AND SYSTEM FOR THE SAME

(71) Applicant: PANTECH CO., LTD., Seoul (KR)

(72) Inventor: Sung Ho PARK, Seoul (KR)

(73) Assignee: PANTECH CO., LTD., Seoul (KR)

(21) Appl. No.: 13/683,119

(22) Filed: Nov. 21, 2012

(30) Foreign Application Priority Data
Mar. 13, 2012 (KR) 10-2012-0025336

(51) Int. Cl. G06F 3/14

(52) U.S. Cl. 715/751

(57) ABSTRACT

A source device, system and method for managing displaying of information on a sink device including a sink device connection determining unit to determine whether an external sink device is connected to the source device, a page configuring unit to generate a virtual page interlinked with the sink device and to connect the virtual page to a basic page where the sink device is communicatively connected to the source device; a display unit to display the basic page or the virtual page, and a page processing unit to output frame data for displaying the basic page and the virtual page, respectively, to the display unit and to transmit the frame data for displaying the virtual page and update information of the virtual page to the sink device. Accordingly, the virtual page of the sink device may be managed and displayed independently from the basic page displayed at the source device.

### CROSS-REFERENCE TO RELATED APPLICATION

This application claims priority to and the benefits under 35 U.S.C. §119 of Korean Patent Application No. 10-2012-0025336, filed on Mar. 13, 2012, the contents of which are herein incorporated in its entirety by reference for all purposes as if fully set forth herein.

### BACKGROUND

1. Field

Exemplary embodiments relate to a source device, system, and method for managing a sink device by generating a separate virtual page for the same.

2. Discussion of the Background

Wireless communication techniques are used in industrial fields including not only communication fields but also service fields. Accordingly, various kinds of services based on a wireless network such as voice call, data transmission and Internet are provided, and the wireless communication techniques based on such a wireless network are, for example, Wireless Broadband internet (WiBro), Wireless Fidelity (WiFi) or the like.

WiFi is a wireless communication technique based on the IEEE 802.11 standards and may be a wireless local area network (LAN) technique, which may use a wireless technology such as High Fidelity (Hi-Fi), and may allow high-performance wireless communication. The wireless LAN technique may construct a network by using radio waves or light waves, without using a wired technique, for example.

If such a WiFi technique is used, a portable computer, such as a notebook computer, may be connected to a WiFi network and may be used in a wireless manner. In addition, if the WiFi technique is used, a plurality of PCs may be connected to transmit large-sized files, as well as graphic, video and audio data. Wireless Ethernet of WiFi may operate at a speed of 11 Mbps per second and may be used within a house or office within a radius of 500 m under optimal conditions, for example.

Further, as mobile terminals using WiFi, such as smart phones, have been recently propagated, users may make WiFi connections, such as by using such a mobile terminal. In addition, a mobile terminal may also have various functions, such as games, moving picture or broadcast regeneration or the like, for example.

However, a mobile terminal may have a relatively small screen for easy portability. Even though the mobile terminal may be connected to an external display device having a large screen to display the screen of the mobile terminal at the external display device, this may enlarge the screen of the mobile terminal.

In other words, since the external display device may share the screen of the mobile terminal, the external display device may display a screen that is displayed on the mobile terminal, such as while using functions of the mobile terminal, such as navigating on a wallpaper of the mobile terminal, executing an application, using a web browser or the like.

For example, where a smart phone may be connected to a television (TV), while regenerating a music video on YouTube® and watching the same music video on the TV, a user may not be able to move to another page at the smart phone to separately use short message service (SMS), phone or chatting service. If the user moves to another page, the TV may also display the moved to page on its screen.

### SUMMARY

Exemplary embodiments relate to apparatus and methods for using a source device independently, separate from the screen of an external display device to display information. Exemplary embodiments of the invention provide a source device to manage a sink device to display information. The source device includes, for example, a sink device connection determining unit to determine whether an external sink device is connected, a page configuring unit to generate a virtual page interlinked with the sink device and to connect the virtual page to a basic page, when the sink device is connected to communicate with the source device, a display unit to display the basic page or the virtual page; and a page processing unit to output frame data to display the basic page and the virtual page, respectively, to the display unit and to transmit the frame data for displaying the virtual page and update information of the virtual page to the sink device. Accordingly, the virtual page of the sink device may be managed and displayed independently from the basic page displayed at the source device, according to exemplary embodiments.

Exemplary embodiments of the invention provide a source device to manage displaying of information on a sink device, including: a sink device connection determining unit to determine whether at least one external sink device is communicatively connected to the source device; a page configuring unit to selectively generate at least one basic page and at least one virtual page, and to selectively connect the at least one virtual page to at least one basic page; a display unit to selectively display the at least one basic page and the at least one virtual page; and a page processing unit to selectively output frame data to selectively display the at least one basic page and the at least one virtual page by the display unit of the source device and to selectively transmit to the at least one sink device the frame data for displaying by the at least one sink device the at least one corresponding virtual page.

Exemplary embodiments of the invention also provide a source device to manage displaying of information on a sink device, including: a sink device connection determining unit to determine whether at least one external sink device is communicatively connected to the source device; a page configuring unit to selectively generate at least one basic page and at least one virtual page; a display unit to selectively display the at least one basic page and the at least one virtual page; and a page processing unit to selectively output frame data to selectively display the at least one basic page and the at least one virtual page by the display unit of the source device and to selectively transmit to the at least one sink device the frame data for displaying by the at least one sink device the at least one corresponding virtual page, and the corresponding at least one virtual page transmitted to the sink device being managed by the source device independently from the at least one basic page.

Exemplary embodiments of the invention also provide a method for managing displaying of information transmitted from a source device to a sink device, including: determining whether at least one external sink device is communicatively connected to a source device; selectively generating at least one basic page; selectively generating at least one virtual page; selectively connecting the at least one virtual page to at least one basic page; selectively outputting frame data to selectively display the at least one basic page and the at least one virtual page by a display unit of the source device; and selectively transmitting to the at least one sink device the frame data for displaying by the at least one sink device the at least one corresponding virtual page, when it is determined the at least one sink device is communicatively connected to the source device.

Additional features of the invention will be set forth in the description which follows, and in part will be apparent from the description, or may be learned by practice of the invention.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a source device according to exemplary embodiments of the present invention.

FIG. 2 is a schematic diagram showing a screen displayed by the source device of FIG. 1 where a sink device is not connected to the source device according to exemplary embodiments of the present invention.

FIG. 3 is a schematic view showing a screen displayed by the source device of FIG. 1 where a sink device is connected to the source device according to exemplary embodiments of the present invention.

FIG. 4 is a schematic diagram showing an example of using a sink device where connected to the source device of FIG. 3 according to exemplary embodiments of the present invention.

FIG. 5 is a detailed block diagram showing a virtual page moving unit of FIG. 1 according to exemplary embodiments of the present invention;

FIGS. 6 and 7 are schematic diagrams showing examples of moving to a virtual page according to exemplary embodiments of the present invention.

FIG. 8 is a flowchart for illustrating a method for managing a sink device by using a source device according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

As used throughout a wireless network may include wireless fidelity (WiFi), a wireless broadband (WiBro), and the like, and accordingly should not be construed in a limiting sense or as being limited to a specific scheme.

It will be understood that when an element is referred to as being “connected to” another element, it can be directly connected to the other element, or intervening elements may be present; and, as to wireless communication, may be interpreted as being wirelessly connected, such as a wireless connection between a source device and a sink device.

Hereinafter, a source device may include, for example, handheld, portable or tablet computer or communication devices, and a method for managing displaying information transmitted from a source device to a sink device, will be described in more detail with reference to the drawings, and should not be construed in a limiting sense. Also the source device may include hardware, firmware, or software to perform various functions of the source device in managing displaying information transmitted from the source device for displaying information on a display unit of a sink device, including those described herein, as may be known to one of skill in the art.

Also, a sink device may include, for example, any of various devices or structures used for displaying information can be wired or wireless connected to a source device, and may include another source device, and also may include hardware, firmware, or software to perform various functions in displaying the information, including those described herein, as may be known to one of skill in the art.

Hereinafter, a source device, such as including, for example, a mobile terminal, handheld, portable or tablet computer or communication devices, and a method for managing displaying information transmitted from a source device to a sink device will be described in more detail with reference to the drawings.

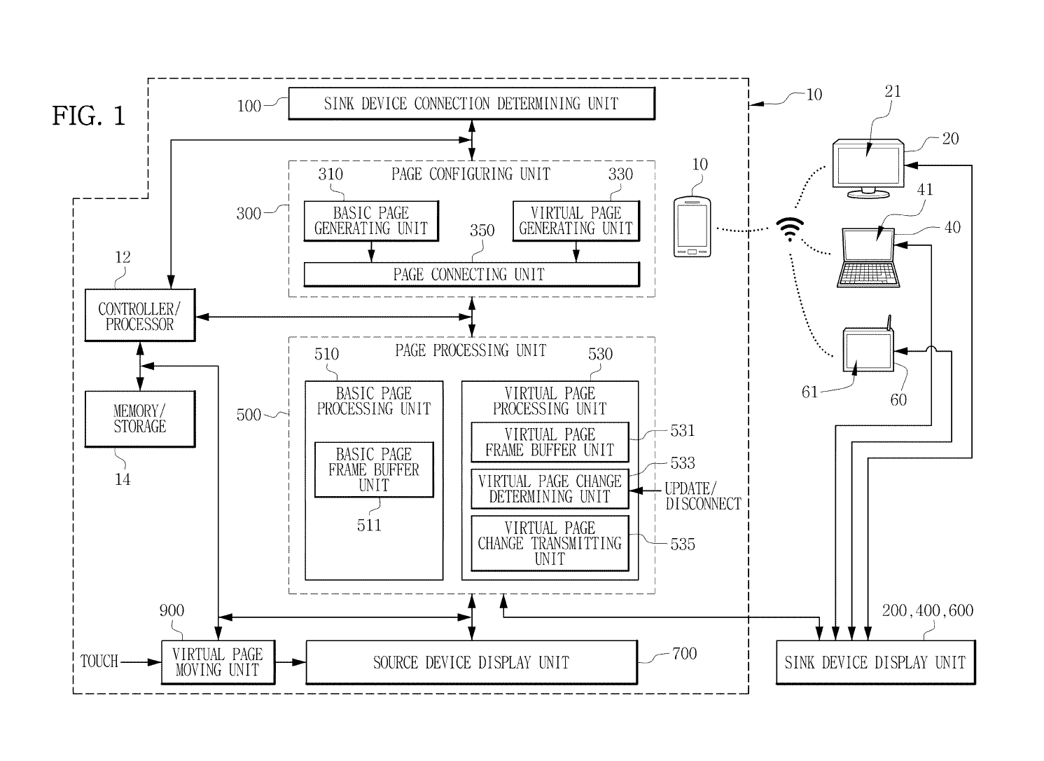

FIG. 1 is a block diagram showing a source device according to exemplary embodiments of the present invention. Although FIG. 1 illustrates the source device as being a mobile terminal, aspects need not be limited as previously described.

Referring to FIG. 1, a system according to exemplary embodiments includes a source device 10 and at least one sink device, such as sink devices 20, 40, 60, spaced apart from the source device 10. Hereinafter, the at least one sink device 20, 40, 60 will be explained with reference to sink device 20 or collectively in relation to sink devices 20, 40 or 60, for example.

The source device 10 may include various kinds of mobile terminals such as smart phones, tablet computers, net books, personal digital assistants (PDA), portable media players (PMP) or the like, which may display a screen in the unit of page, for example. In addition, the source device 10 may execute various application programs based on an operation system (OS) of the source device 10.

The OS is a system program for allowing an application program to use hardware of the computer and may include all kinds of operating systems loadable on a mobile terminal, such as Android OS™, iOS, Window Mobile OS, Bada OS, Simbian OS, BlackBerry OS® or the like, for example.

The application program is a program to perform specific tasks by using a computer, and may include not only applications but also may include multimedia contents, such as games, moving pictures and photographs and programs, such as image viewers and moving picture regenerators, which execute such multimedia content, for example.

The sink device 20 may include not only mobile terminals but also all kinds of display devices capable of receiving frame date from the source device and displaying the frame data, such as desktop computers, monitors, TV and smart TV, for example, and should not be construed in a limiting sense.

The source device 10 and the sink device 20 may be communicatively connected, such as to perform wired or wireless communication, and for example, may perform communication with each other by using a wireless local area network (LAN), for example. The wireless LAN may allow high-speed Internet within a predetermined or reference distance by using radio waves or infrared (IR) rays without using lines, and may include all kinds of wireless local communication techniques, such as Wireless Fidelity (WiFi), for example.

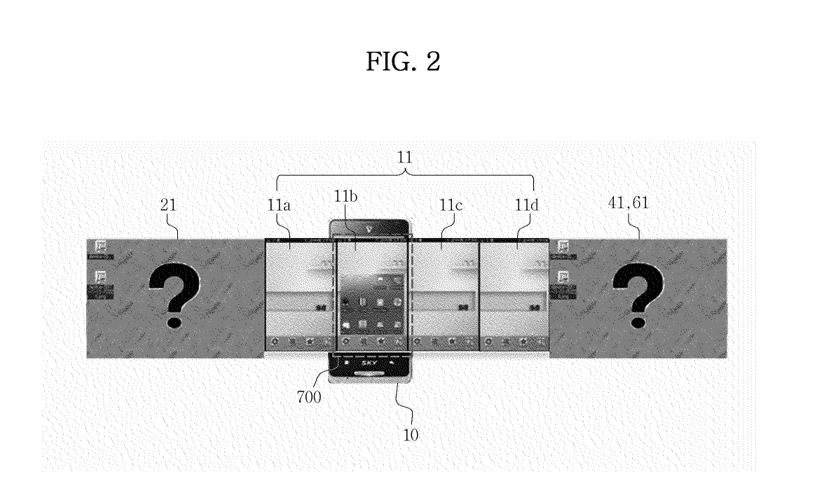

FIG. 2 is a schematic diagram showing a screen displayed by the source device 10 of FIG. 1 where a sink device is not connected to the source device, according to exemplary embodiments of the present invention.

Referring to FIG. 2, the source device 10 according to exemplary embodiments may display only a basic page 11, such as basic pages 11a, 11b, 11c or 11d, at a source device display unit 700 before being connected to the sink device 20, and even when having information about a virtual page 21, 41 or 61 the source device 10 may not display the virtual page 21, 41 or 61 at the source device display unit 700.

The basic page 11 is a wallpaper page provided by the source device 10, and represents a screen unit that may be initially observed by a user through horizontal/vertical navigation or observed in an enlarged or reduced state by a user setting or by adding or editing an application, such as on the source device 10. The basic page 11 may be provided by the source device 10 regardless of the connection of an external sink device 20.

For example, in a case where the source device 10 is based on an Android OS, the basic page 11 has a given number of initial pages, and the number may be increased or decreased by adding an application or by using a user setting. In addition, in case where the source device 10 is based on iOS, the basic page 11 is a screen unit observable through horizontal/vertical navigation, such as by adding an application or using a user edition or a screen unit, such as a search window which appears at a navigation to the leftmost side, for example.

The basic page 11 may be displayed to turn over horizontally or vertically by a touch or rotation applied to the source device 10. The virtual pages 21, 41or 61 may be interlinked with one or more sink devices 20, 40, or 60, respectively, and may be displayed in association with the basic page 11.

According to exemplary embodiments, the virtual page 21 is not displayed until the sink device 20 is connected to the source device 10. However, according to exemplary embodiments, even when the sink device 20 is not yet connected to the source device 10, the virtual page 21, 41 61 may be displayed, and the virtual page 21 may be managed as a page not interlinked with the sink device 20, as represented in FIG. 2.

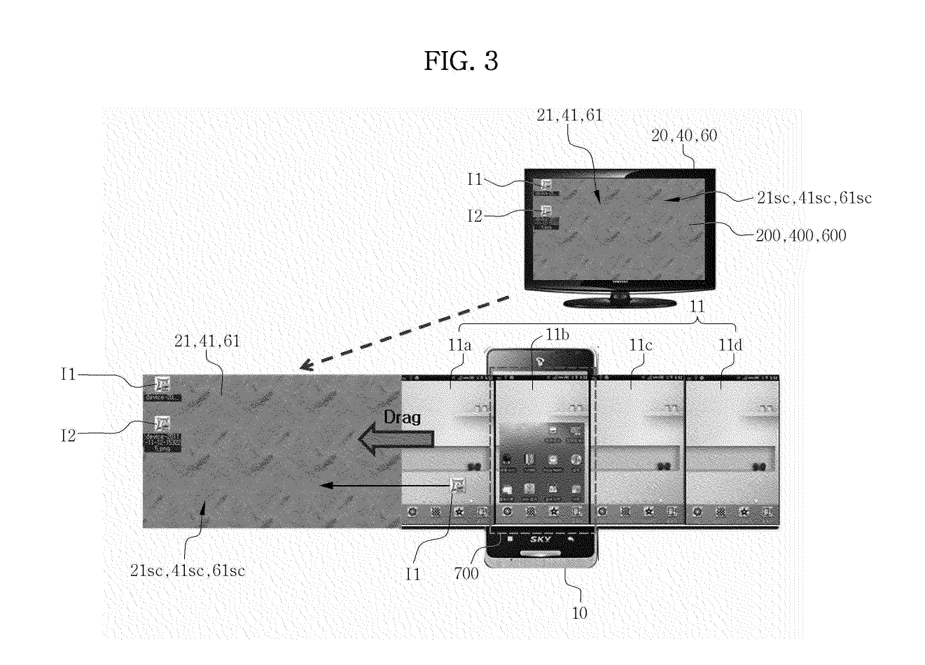

FIG. 3 is a schematic view showing a screen displayed by the source device 10 of FIG. 1 where a sink device 20 is connected to the source device 10, according to exemplary embodiments of the present invention.

Referring to FIG. 3, where the sink device 20 is connected to the source device 10 according to exemplary embodiments, the virtual page 21, where interlinked with the sink device 20, may be displayed at the source device display unit 700.

If the sink device 20 is connected to the source device 10, a corresponding virtual page 21 is activated, and the virtual page 21 is processed to allow page navigation by the manipulation of a user. As a result, the virtual page 21, which is not observable before the sink device 20 is connected, is observed. For example, if the basic page 11, such as basic page 11a, is dragged to the left as shown in FIG. 3, a virtual page 21 appears over the basic page 11.

The screen 21sc of the virtual page 21 displayed at the source device 10 is also displayed at the sink device 20 such as on sink device display unit 200, for example. In addition to the exemplary screen 21sc, other exemplary screens, such as 41sc or 61sc, as corresponding to virtual pages 41 or 61, are illustrated as may be displayed on the source device 10 and on corresponding sink devices 40 or 60, for example. The user of a source device 10 may execute various applications, games, moving pictures or the like at the virtual page 21 and display them at the sink device 20, such as may have a relatively a large screen.

Particularly, even when the source device 10 displays the basic page 11 again, such as basic page 11a, the sink device 20 may still display the virtual page 21. Therefore, by recognizing the screen of the sink device 20 as a partial page of the source device 10, the user may manage the basic page 11, such as basic page 11a, while managing a screen, such as screen 21sc corresponding to virtual page 21, to be displayed at the sink device 20 as a separate virtual page 21, for example.

In addition, since the virtual page 21 may provide functions related to dragging or icons, the user may move an icon, such as icon I1, formed at the basic page 11, such as basic page 11a, to the virtual page 21, such as illustrated by the arrow in FIG. 3, or edit the virtual page 21 as, for example, by generating a new icon, such as icon I2, at the virtual page 21. Therefore, by managing the virtual page 21, managing the interlinked sink device 20 may likewise be facilitated.

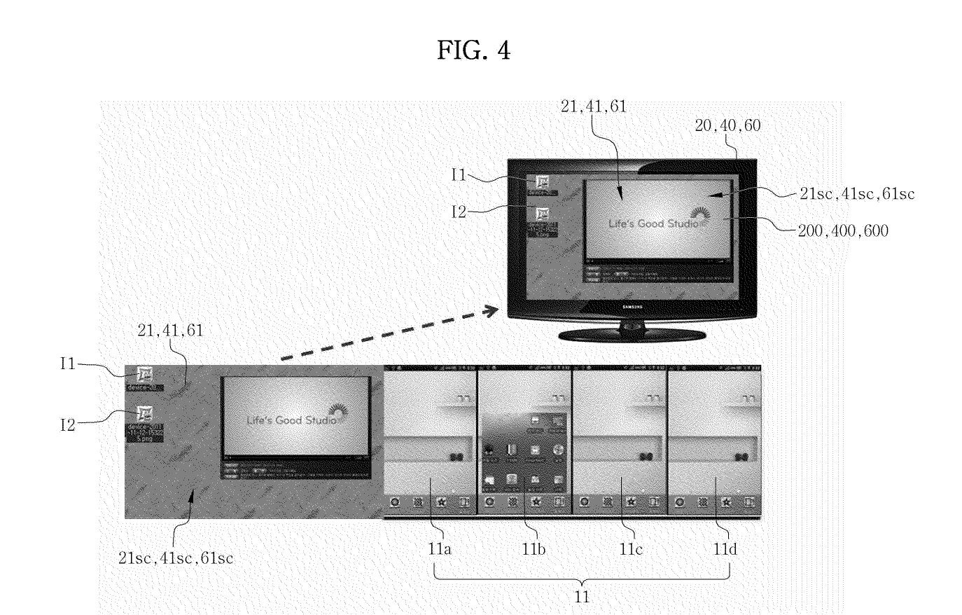

FIG. 4 is a schematic diagram showing an example of using a sink device 20 of FIG. 3 according to exemplary embodiments of the present invention.

Referring to FIG. 4, where a moving picture is regenerated at the virtual page 21, the moving picture is also displayed at the sink device 20 interlinked with the virtual page 21. In this case, even when the source device 10 moves to the basic page 11, such as basic page 11a, again, the sink device 20 still displays the virtual page 21 where the moving picture is generated, according to exemplary embodiments.

Therefore, the user may perform other tasks on the source device 10, such as sending a short message service (SMS) or making a call, while watching the desired moving picture on the sink device display unit 200 of sink device 20, for example. Hereinafter, the source device 10 for performing these and other functions according to exemplary embodiments will be further described.

Referring to FIG. 1 again, the source device 10 according to exemplary embodiments includes a sink device connection determining unit 100, a page configuring unit 300, a page processing unit 500 and the source device display unit 700. The source device 10 may further include a virtual page moving unit 900. Also, the source device 10 may include a controller/processor 12 for implementing the operations and functions of the source device or mobile terminal 10 according to exemplary embodiments. The source device 10 may further include a memory/storage 14 for storing software, programs, instructions, or data used for implementing the operations and functions of the source device 10 according to exemplary embodiments.

All or part of one or more of the controller/processor 12 or the memory/storage 14 may be integrated with one or more of the above-described sink device connection determining unit 100, page configuring unit 300, page processing unit 500, source device display unit 700 or virtual page moving unit 900 for implementing the operations and functions of the source device 10 according to exemplary embodiments.

The controller/processor 12, the memory/storage 14 the sink device connection determining unit 100, page configuring unit 300, page processing unit 500, source device display unit 700 or virtual page moving unit 900 may include any of various memory or storage media for storing software, program instructions, data files, data structures, and the like, and may also include any of various processors, computers or application specific integrated circuits (ASICs) for example, to implement various operations in managing displaying of information transmitted from a source device 10 to a sink device, such as sink devices 20, 40, or 60, as described herein.

The software, media and program instructions may be those specially designed and constructed for the purposes of the present invention, or they may be of the kind well-known and available to those having skill in the computer software arts. Examples of program instructions include both machine code, such as produced by a compiler, and files containing higher level code that may be executed by the computer using an interpreter. The described hardware devices may, for example, include hardware, firmware or other modules to perform the operations of the described embodiments of the present invention.

The sink device connection determining unit 100 determines whether at least one sink device 20 is communicatively connected to the source device 10. The communicative connection of the sink device 20, or sink devices 40 or 60, may be performed according to a wired or wireless connection to the source device 10 or by registering an external device by an input of a connection signal. Where the sink device 20 is connected to the source device 10, the sink device connection determining unit 100 may provide a connection event to the page configuring unit 300.

The page configuring unit 300 may selectively generate one or more of at least one basic page 11, such as basic pages, 11a, 11b, 11c or 11d, or at least one virtual page, such as virtual pages 21, 41 or 61, to selectively interlink the at least one virtual page 21 with the corresponding at least one sink device, such as sink devices 20, 40 or 60, where the sink device connection determining unit 100 determines the at least one sink device 20, 40 or 60 is communicatively connected to the source device 10, and to selectively connect the at least one virtual page 21, 41 or 61 to the corresponding sink device 20, 40 or 60, according to exemplary embodiments.

In a case where the sink device 20 is connected to the source device 10, the page configuring unit 300 generates a virtual page 21 interlinked with the connected sink device 20 and connects the virtual page 21 to the basic page 11. In this regard, the page configuring unit 300 may include a basic page generating unit 310, a virtual page generating unit 330 and a page connecting unit 350.

The basic page generating unit 310 selectively generate the at least one basic page 11, such as basic pages 11a, 11b, 11c or 11d, whether or not the source device 10 is connected to the sink device 20. The basic page 11 may include at least one page or a plurality of basic pages. For example, FIG. 2, FIG. 3 and FIG. 4 depict the above described four basic pages 11a, 11b, 11c or 11d, for example.

The virtual page generating unit 330 selectively generates at least one virtual page, such as virtual pages 21, 41 or 61, interlinked with at least one connected sink device, such as sink devices 20, 40 or 60, for example. The virtual page generating unit 330 may further include an internal storage unit, or be integrated with or part of memory/storage 14 for storing the information of the virtual page 21 of the sink device 20, and the information may be used when the virtual page generating unit 330 selectively generates the virtual page, such as virtual page 21, for example.

The page configuring unit 300 may selectively generate a plurality of virtual pages 21, 41 or 61 to interlink with corresponding ones of a plurality of sink devices 20, 40 or 60, where the sink device connection determining unit 100 determines the plurality of sink devices 20, 40 or 60 are connected to the source device 10, according to exemplary embodiments.

Where two or more sink devices 20, 40, 60 are connected to the source device 10, the virtual page generating unit 330 separately generates virtual pages, such as virtual pages 21, 41 or 61, respectively interlinked with the sink devices 20, 40, 60. The virtual pages 21, 41 or 61 may be configured with a single page, for example. In addition, where the sink device 20, 40 or 60 is respectively connected to source device 10 and then another sink device 20, 40 or 60 is connected, at least one new virtual page 21, 41or 61 may be selectively generated and respectively added, for example. Accordingly, the source device 10 may facilitate managing one or more sink devices, such as sink devices 20, 40 or 60, by managing a corresponding virtual page, such as virtual pages 21, 41 or 61, interlinked with a corresponding sink device 20, 40, or 60, according to exemplary embodiments, for example.

The page connecting unit 350 connects the generated basic page 11, such as basic pages 11a, 11b, 11c or 11d, and the at least one generated virtual page, such as virtual pages 21, 41 or 61, according to exemplary embodiments, for example, to allow switching between the connected basic page 11 and the virtual page 21, 41, or 61 by a drag or other operation. The connected virtual page 21, 41 or 61 may have the same number of pages as the number of the connected sink devices 20, 40, 60, for example.

The page processing unit 500 selectively outputs frame data to selectively display one or more of the at least one basic page 11, such as basic pages 11a, 11b, 11c or 11d, and at least one virtual page, such as virtual page 21, 41 or 61, respectively, to the source device display unit 700. And selectively transmits to the at least one sink device 20, 40 or 60, the frame data for displaying on the corresponding sink device display unit 200, 400 or 600, the at least one virtual page 21, 41 or 61, or update information of a corresponding virtual page 21, 41 or 61, according to exemplary embodiments.

The page processing unit 500 may output frame data to selectively display one or more of the at least one basic page 11, such as basic pages 11a, 11b, 11c or 11d, and to selectively display a plurality of virtual pages, such as virtual pages 21, 41 or 61, by the source device display unit 700, and to selectively transmit to a plurality of sink devices, such as sink devices 20, 40 or 60, one or more of frame data for displaying the corresponding virtual pages, such as 21, 41 or 61, or update information of one or more of the corresponding virtual pages 21, 41 or 61, according to exemplary embodiments, for example.

The page processing unit 500 may include a basic page processing unit 510 for outputting the frame data for displaying the at least one basic page 11, such as basic pages 11a, 11b, 11c or 11d, and a virtual page processing unit 530 for outputting one or more the frame data for displaying the at least one virtual page 21, 41 or 61, or the update information for a corresponding virtual page 21, 41 or 61, according to exemplary embodiments.

The basic page processing unit 510 may provide the at least one basic page 11, such as basic pages 11a, 11b, 11c or 11d, by selectively outputting frame data corresponding to the at least one basic page, such as basic pages 11a, 11b, 11c or 11d, at the same ratio according to or at a screen ratio of the source device display unit 700 of the source device 10, according to exemplary embodiments. The basic page processing unit 510 may include a basic page frame buffer unit 511 to buffer the frame data and for selectively outputting the frame data for displaying the at least one basic page 11, such as basic pages 11a, 11b, 11c or 11d, through the frame buffer, such as may be provided in conjunction with the memory/storage 14, for example.

The virtual page processing unit 530 may provide the at least one virtual page 21, 41 or 61, by selectively outputting frame data corresponding to the at least one virtual page, such as virtual pages 21, 41 or 61, at the same ratio according to or at a screen ratio of the display unit 200, 400 or 600, of the corresponding at least one sink device 20, 40 or 60, instead of at the screen ratio of the display unit 700 of the source device 10, according to exemplary embodiments. The virtual page processing unit 530 may include a virtual page frame buffer unit 531 to buffer the frame data and for outputting the frame data for displaying the at least one virtual page 21, 40 or 61, through the frame buffer, such as may be provided in conjunction with the memory/storage 14, for example.

The display unit 700 of the source device 10 and the display unit 200, 400 or 600 of the at least one sink device 20, 40 or 60, may receive and display the frame data for displaying the corresponding virtual page 21, 41 or 61, for example. In addition, even when the display unit 700 of the source device 10 displays the basic page 11, such as basic page 11a, 11b, 11c or 11d, the display unit 200, 400 or 600 of the corresponding sink device 20, 40 or 60 may continuously receive the frame data for displaying the corresponding virtual page 21, 41 or 61 and display the virtual page 21, 41 or 61, respectively, according to exemplary embodiments.

In addition, the virtual page processing unit 530 may include a virtual page change determining unit 533 for determining whether the at least one virtual page 21, 41 or 61 is changed from a corresponding previous virtual page 21, 41 or 61. And may include a virtual page change transmitting unit 535 to output corresponding update information of a changed virtual page 21, 41 or 61, as may be determined by the virtual page change determining unit 533, and to selectively transmit the at least one changed virtual page 21, 41 or 61 to the source device display unit 700 and to the corresponding sink device 20, 40 or 60, according to exemplary embodiments.

Where the virtual page change determining unit 533 determines that the at least one virtual page 21, 41 or 61 is changed, the virtual page change transmitting unit 535 may output the update information of the corresponding virtual page 21, 41 or 61 to the source device display unit 700 and may selectively transmit the update information of the corresponding virtual page 21, 41 or 61 to the respective sink device 20, 40 or 60. For example, the change of the at least one virtual page 21, 41 or 61 may be an execution of another application, an editing of the virtual page 21, 41 or 61, such as by generation of an icon, disconnection of the virtual page 21 41 or 61, a movement to another virtual page, such as from virtual page 21 to virtual page 41, or the like, for example. The change of the at least one virtual page 21, 41 or 61 may be determined according to an input of an update event, for example.

Where a disconnection event of the at least one virtual page 21, 41 or 61 is input to the virtual page change determining unit 533, the virtual page change transmitting unit 535 separates the virtual page 21, 41 or 61 from the basic page 11, such as basic page 11a, 11b, 11c or 11d, and releases the connection to the corresponding sink device 20, 40 or 60, according to exemplary embodiments. Accordingly, the source device display unit 700 of the source device 10 may display only the basic page 11, such as basic page 11a, 11b, 11c or 11d, and may then not display the at least one virtual page 21, 41 or 61, based on the corresponding disconnection event. In addition, the transmission of the frame data for displaying the corresponding virtual page 21, 41 or 61 and the corresponding update information to the respective sink device 20, 40 or 60 may likewise be stopped, based on the disconnection event.

The disconnection event may be provided from the sink device connection determining unit 100, such as in response to a signal input corresponding to the disconnection event input by a user of the source device 10, for example.

Where the sink device 20, 40 or 60 is disconnected, the information about the corresponding virtual page 21, 41 or 61 of the respective sink device 20, 40 or 60 may be backed up in the internal storage unit of the virtual page generating unit 330, such as may be provided in conjunction with the memory/storage 14, for example. The information about the disconnected virtual page 21, 41 or 61 as may be stored in the internal storage unit or memory/storage 14 may be used for generating or activating a corresponding virtual page 21, in a case where the sink device 20 is connected again to the source device 10.

In this regard, after occurrence of a disconnection event, according to exemplary embodiments, the source device 10 may store information to generate a corresponding virtual page 21, 41 or 61 as may be transmitted by the source device 10 to a corresponding sink device 20, 40 or 60, where the corresponding sink device 20, 40 or 60 is communicatively disconnected from the source device 10. And the source device 10 may selectively transmit to the at least one sink device 20, 40 or 60 frame data corresponding to the stored information for displaying by the at least one sink device 20, 40 or 60 the corresponding virtual page 21, 41 or 61, where the corresponding sink device 20, 40 or 60 is again communicatively connected to the source device 10.

Where the connection to the sink device 20, 40 or 60 is released, the display unit 700 may display only the basic page 11, such as basic pages 11a, 11b, 11c or 11d, but in a case where the sink device 20, 40 or 60 is connected to the source device 10, the display unit 700 may display the basic page 11, such as basic pages 11a, 11b, 11c or 11d, or the at least one virtual page 21, 41 or 61, such as according to a user selection implemented by the source device 10, for example. Also, where the display unit 700 displays the basic page 11, such as basic pages 11a, 11b, 11c or 11d, it may be possible to move directly to the virtual page 21 41, or 61; and where a virtual page, such as virtual page 21 is displayed, it is possible to move to another virtual page, such as to virtual page 41 or 61, which may facilitate management of the corresponding at least one sink device 20, 40 or 60, for example.

The virtual page moving unit 900 of the source device 10 as may support a screen, such as screen 21sc, 41sc or 61sc, to be converted to a corresponding virtual page, such as virtual page 21, 41 or 61, will be described.

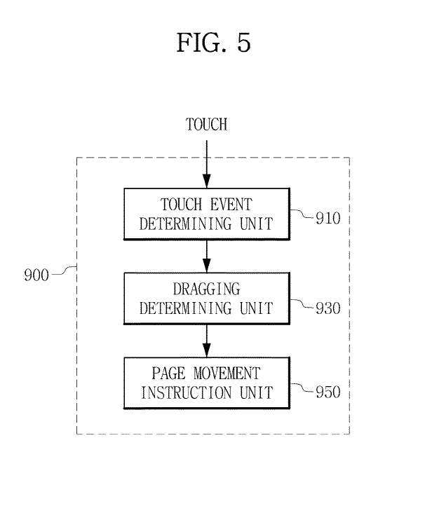

FIG. 5 is a block diagram showing the virtual page moving unit 900 of FIG. 1, according to exemplary embodiments of the present invention.

The virtual page moving unit 900 may change a screen of the source device display unit 700 so that the source device display unit 700 may display the corresponding virtual page 21, 41 or 61 according to a virtual page moving signal generated by the virtual page moving unit 900, according to exemplary embodiments. Accordingly, where a number of the basic pages 11, such as basic pages 11a, 11b, 11c or 11d, may be large or where a plurality of virtual pages, such as virtual pages 21, 41 or 61, may be generated, it may be possible to reduce dragging to change screens displayed by the source device display unit 700, for example.

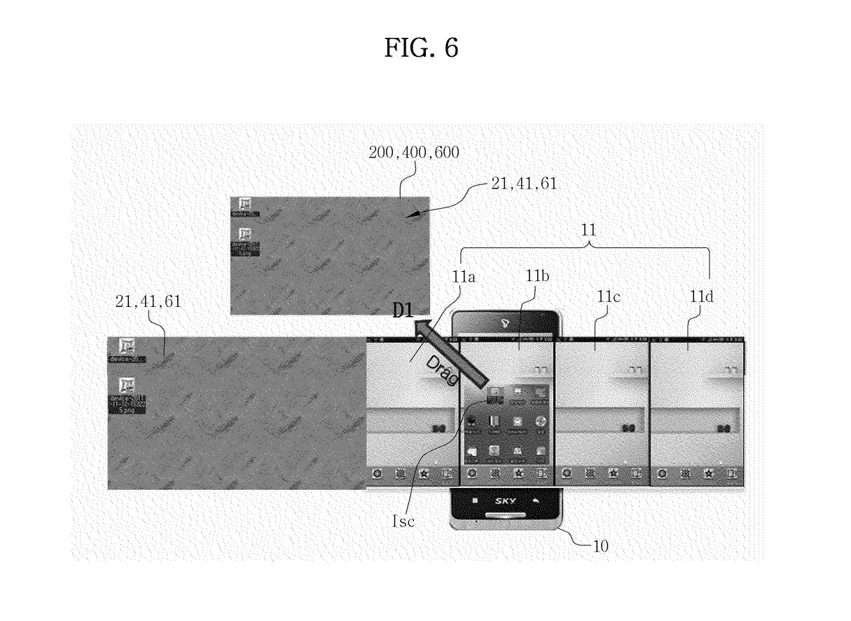

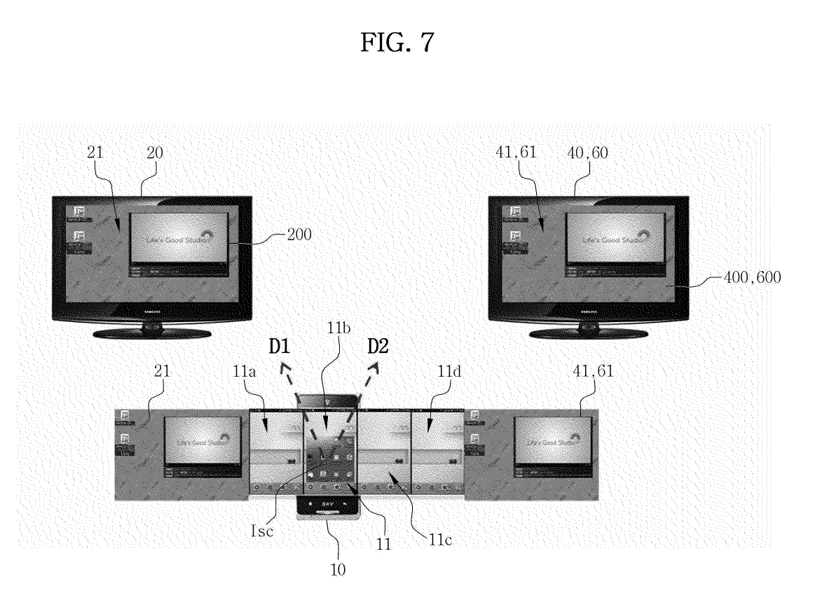

According to exemplary embodiments, the virtual page moving unit 900 may include a shortcut icon Isc (See, FIG. 6 and FIG. 7, for example), and the screen of the source device display unit 700 may be changed to the corresponding virtual page 21, 41 or 61, such as by executing the operation associated with the shortcut icon Isc, according to exemplary embodiments, for example.

Also, according to exemplary embodiments, the virtual page moving unit 900 may change a screen of the source device display unit 700 to a corresponding virtual page 21, 41 or 61, such as according to a touch event applied to the source device display unit 700 and implemented by the virtual page moving unit 900.

Referring to FIG. 5, the virtual page moving unit 900 according to exemplary embodiments may include a touch event determining unit 910 for determining whether a touch event is input to the source device display unit 700 of the source device 10. And may include a dragging determining unit 930 for determining a dragging direction where the touch event is input to the source device display unit 700 of the source device 10 as a dragging motion on the source device display unit 700. And also may include page movement instruction unit 950 for moving to a virtual page corresponding to the dragging direction on the source device display unit 700.

FIG. 6 and FIG. 7 are schematic diagrams showing examples of moving to a virtual page according to exemplary embodiments of the present invention.

Referring to FIG. 6, where dragging is performed at the source device display unit 700 in a first direction D1, such as by dragging, rather than executing on, the shortcut icon Isc, or by dragging one or more other screen designators, for example, the screen displayed at the source device display unit 700 is changed to a virtual page 21 corresponding to the first direction D1, for example. The virtual page 21 corresponding to the first direction D1 may be set in advance and stored by the controller/processor 12 in the memory/storage 14, such as may by associated with the virtual page moving unit 900, for example.

Similarly, referring to FIG. 7, where dragging is performed at the source device display unit 700 in the first direction D1, such as by dragging, rather than executing on, the shortcut icon Isc, or by dragging one or more other screen designators, for example, the screen displayed at the source device display unit 700 is changed to the virtual page 21 corresponding to the first direction D1, and where dragging is performed at the source device display unit 700 in a second direction D2, the screen displayed at the source device display unit 700 is changed to a virtual page 41or 61 corresponding to the second direction D2, for example. The virtual page 21 corresponding to the first direction D1 and the virtual page 41 or 61 corresponding to the second direction D2 may be set in advance and stored by the controller/processor 12 in the memory/storage 14, such as may by associated with the virtual page moving unit 900, for example.

According to the source device 10 and systems including the source device 10, according to exemplary embodiments, since the source device 10 may generate and may manage the virtual page 21, 41 or 61 for managing the corresponding communicatively connected sink device 20, 40 or 60, the corresponding virtual page 21, 41 or 61 may be displayed at the corresponding sink device 20, 40 or 60, separately from the basic page 11, such as basic pages 11a, 11b, 11c or 11d, displayed at the source device 10.

In addition, by managing the generated virtual page 21, 41 or 61, managing the corresponding sink device 20, 40 or 60 may be likewise facilitated. Furthermore, since the source device display unit 700 of the source device 10 may directly move to the corresponding virtual page 21, 41 or 61 and display the corresponding virtual page 21, 41 or 61, efficiency in management of the at least one sink device 20, 40 or 60 may also be facilitated.

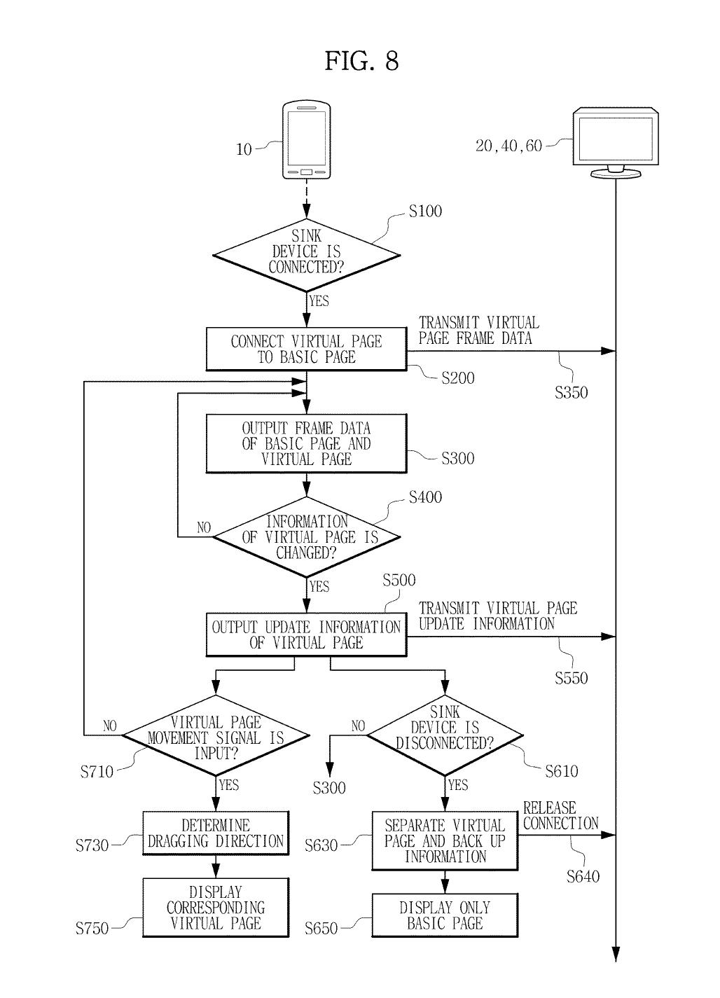

FIG. 8 is a flowchart for illustrating a method for managing at least one sink device 20, 40 or 60 by using a source device, such as source device 10, according to exemplary embodiments of the present invention.

Referring to FIG. 8, the source device 10 determines whether an external sink device 20, 40 or 60 is communicatively connected to the source device 10, such as by a wired or wireless connection, for example (S100).

The communicative connection of the at least one sink device 20, 40 or 60 may be performed according to a wired or wireless connection to the source device 10 or by registering an external device, such as the sink device 20, 40 or 60, by an input of a connection signal to the source device 10, for example. Where the sink device 20, 40 or 60 is communicatively connected to the source device 10, a connection event may be provided to the source device 10.

In a case where the sink device 20, 40 or 60 is communicatively connected to the source device 10, a virtual page 21, 41 or 61 interlinked with the corresponding sink device 20, 40 or 60 is generated and connected to the basic page 11, such as basic pages 11a, 11b, 11c or 11d, for example, (S200).

Operation 5200 may include generating the basic page 11, such as basic pages 11, 11b, 11c or 11d, whether or not the source device 10 is communicatively connected to the sink device 20, 40 or 60, and may generate the corresponding virtual page 21, 41 or 61 interlinked with the connected sink device 20 40 or 60, and may connect the generated virtual page 21, 41 or 61 to the generated basic page 11, such as basic pages 11a, 11b, 11c or 11d, for example.

The source device 10 may output the frame data for displaying the basic page 11, such as basic pages 11a, 11b, 11c or 11d, and the frame data for displaying the virtual page 21, 41 or 61, and may selectively display one or more of the basic page 11, such as basic pages 11a, 11b, 11c or 11d or the at least one virtual page 21, 41 or 61 (S300) such as on the source device display unit 700. In addition, the source device 10 may transmit the corresponding frame data for displaying the at least one virtual page 21, 41or 61 to the corresponding sink device 20, 40 or 60 (S350).

The source device 10 and the sink device 20, 40 or 60 may receive and display the frame data for displaying the at least one virtual page 21, 41 or 61. In addition, even when the source device 10 displays the basic page 11, such as basic pages 11a, 11b, 11c or 11d, the sink device 20, 40 or 60 may continuously receive the corresponding frame data for displaying the corresponding virtual page 21, 41 or 61 and may display the virtual page 21, 41 or 61.

Proceeding to operation 5400, it is then determined whether the virtual page 21, 41 or 61 is changed (S400). For example, the change of the virtual page 21, 41 or 61 may result from an execution of another application, an editing of the virtual page 21, 41 or 61, such as may be from generation of an icon, a disconnection of the virtual page 21, 41 or 61, a movement to another virtual page, such as from virtual page 21 to virtual page 41, or the like. The change of the virtual page 21 may be determined according to an input of an update event, for example, to the source device 10.

Where the virtual page 21, 41 or 61 is changed, the corresponding update information of the virtual page 21, 41 or 61 is output and displayed on the source device display unit 700 (S500). In addition, the corresponding update information of the virtual page 21, 41 or 61 is transmitted to the corresponding sink device 20, 40 or 60 (S550). And where the virtual page 21, 41 or 61 may not be changed, the process returns to operation S300 and proceeds as previously described.

Where the change of the virtual page 21, 41 or 61 is a disconnection of the sink device 20, 40 or 60 from the source device 10, it is determined whether a corresponding disconnection event is input (S610). Where the disconnection event is input, the corresponding virtual page 21, 41 or 61 is separated from the basic page 11, such as basic pages 11a, 11b, 11c or 11d, and the information about the virtual page 21, 41 or 61 may be backed up in the internal storage unit, such as may be associated with the memory/storage 14 (S630). Accordingly, the source device 10 may display on the source device display unit 700 only the corresponding basic page 11, such as basic pages 11a, 11b, 11c or 11d, and may no longer display thereon the corresponding virtual page 21, 41 or 61 corresponding to the disconnection event (S650).

In addition, where the disconnection event is input to the source device 10, the connection to the sink device 20 40 or 60, that corresponds to the disconnection event, is released (S640). Accordingly, the transmission from the source device 10 of the frame data for displaying the corresponding virtual page 21, 41 or 61, as well as corresponding update information to the corresponding sink device 20, 40 or 60, is stopped, based upon the disconnection event being input. And where the disconnection event is not input (S610), the process returns to operation S300 and proceeds as previously described.

Where the change of the virtual page 21 is a page movement, it is determined whether a virtual page moving signal is input, such as may be generated by the virtual page moving unit 900, for example (S710). As previously described, the virtual page moving signal may be an execution signal of a shortcut icon or a touch event.

The determination at operation S710 for changing the screen to the corresponding virtual page 21, 41 or 61 according to the touch event may include determining whether a touch event is input, may determine a dragging direction where the touch event is input (S730), and may move to or display a virtual page 21, 41 or 61 corresponding to the dragging direction (S750). Also, as previously described, the virtual page corresponding to the dragging direction may be set in advance, for example. Where a virtual page movement signal is not input, the process returns to operation S300 and proceeds as previously described.

According to the methods according to exemplary embodiments for managing the at least one sink device 20, 40 or 60, such as by using the source device 10, since the virtual page 21, 41 or 61 for managing the corresponding sink device 20, 40 or 60 may be generated and managed, a virtual page 21, 41 or 61 may be displayed at the corresponding sink device 20, 40 or 60, separately from the corresponding basic page 11, such as basic pages 11a, 11b, 11c or 11d, displayed at the source device 10, for example.

In addition, by managing the generated at least one virtual page 21, 41 or 61, managing the corresponding sink device 20, 40 or 60 may be facilitated in a convenient manner. Furthermore, the source device display unit 700 of the source device 10 may move to the corresponding virtual page 21, 41 or 61 and may provide for displaying, in a reduced time, the corresponding virtual page 21, 41 or 61. And, therefore, management efficiency in managing the at least one sink device 20, 40 or 60 may be facilitated.

According to methods for managing a sink device, and a source device and system, according to exemplary embodiments, a sink device communicatively connected to the source device may be recognized as a separate virtual page so that the virtual page of the corresponding sink device may be managed and displayed independently from the basic page displayed at the source device.

Therefore, according to exemplary embodiments, the source device may manage the transmission of the corresponding at least one virtual page to the at least one corresponding sink device independently from one or more of generating or displaying the at least one basic page. In addition, managing of the sink device may be facilitated by providing an icon or dragging to the virtual page. Further, since a relatively rapid movement to the corresponding virtual page may be utilized, a more efficient management of the sink device may be promoted.

Also, the exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A source device to manage displaying of information on a sink device, the source device comprising:
a sink device connection determining unit to determine whether at least one external sink device is communicatively connected to the source device;
a page configuring unit to selectively generate at least one basic page and at least one virtual page, and to selectively connect the at least one virtual page to at least one basic page;
a display unit to selectively display the at least one basic page and the at least one virtual page; and
a page processing unit to selectively output frame data to selectively display the at least one basic page and the at least one virtual page by the display unit of the source device and to selectively transmit to the at least one sink device the frame data for displaying by the at least one sink device the at least one corresponding virtual page.

2. The source device of claim 1, wherein the corresponding at least one virtual page transmitted to the at least one sink device is managed by the source device independently from the at least one basic page.

3. The source device of claim 1, wherein the page configuring unit comprises:
a basic page generating unit to selectively generate the at least one basic page;
a virtual page generating unit to selectively generate the at least one virtual page to the at least one corresponding connected sink device; and
a page connecting unit to selectively connect the at least generated one virtual page to at least one generated basic page.

4. The source device of claim 1, wherein page processing unit further comprises:
a basic page processing unit to output the frame data to display the at least one basic page; and
a virtual page processing unit to output the frame data to display the at least one virtual page and, when updated, the update information for a corresponding virtual page.

5. The source device of claim 4, wherein the basic page processing unit comprises:
a basic page frame buffer unit to buffer the frame data to display the at least one basic page.

6. The source device of claim 4, wherein the virtual page processing unit comprises:
a virtual page frame buffer unit to buffer the frame data to output the frame data to display the at least one virtual page;
a virtual page change determining unit to determine whether the at least one virtual page is changed from a corresponding previous virtual page; and
a virtual page change transmitting unit to output corresponding update information of a changed virtual page, determined by the virtual page change determining unit, and to selectively transmit the changed virtual page to the display unit or to the corresponding sink device.

7. The source device of claim 4, wherein the at least one corresponding virtual page transmitted to the at least one sink device is managed by the source device independently from the at least one basic page.

8. The source device of claim 1, wherein each of the at least one virtual page transmitted to the corresponding at least one sink device by the source device is different.

9. The source device of claim 1, wherein the at least one virtual page transmitted to the corresponding at least one sink device includes a same virtual page.

10. The source device of claim 1, further comprising:
a virtual page moving unit to change a screen of the display unit of the source device to display a corresponding virtual page, based on a virtual page moving signal generated by the virtual page moving unit.

11. The source device of claim 10, wherein the virtual page moving signal is generated by one or more of a shortcut icon displayed on the display unit and a touch event, when applied, to the display unit.

12. The source device of claim 10, wherein the virtual page moving unit comprises:
a touch event determining unit to determine whether a touch event is input to the display unit of the source device;
a dragging determining unit to determine a dragging direction where the touch event input is a dragging motion on the display unit of the source device; and
a page movement instruction unit to move to a virtual page corresponding to the dragging direction on the display unit of the source device.

13. The source device of claim 1, wherein the page configuring unit selectively interlinks the at least one virtual page with a corresponding at least one sink device, when the sink device connection determining unit determines the at least one sink device is communicatively connected to the source device.

14. The source device of claim 1, wherein the page processing unit selectively transmits to the at least one sink device, when updated, update information of a corresponding virtual page.

15. A source device to manage displaying of information on a sink device, the source device comprising:
a sink device connection determining unit to determine whether at least one external sink device is communicatively connected to the source device;
a page configuring unit to selectively generate at least one basic page and at least one virtual page;
a display unit to selectively display the at least one basic page and the at least one virtual page; and
a page processing unit to selectively output frame data to selectively display the at least one basic page and the at least one virtual page by the display unit of the source device and to selectively transmit to the at least one sink device the frame data for displaying by the at least one sink device the at least one corresponding virtual page, and the corresponding at least one virtual page transmitted to the sink device being managed by the source device independently from the at least one basic page.

16. A method for managing displaying of information transmitted from a source device to a sink device, the method comprising:
determining whether at least one external sink device is communicatively connected to a source device;
selectively generating at least one basic page;
selectively generating at least one virtual page;
selectively connecting the at least one virtual page to at least one basic page;
selectively outputting frame data to selectively display the at least one basic page and the at least one virtual page by a display unit of the source device; and
selectively transmitting to the at least one sink device the frame data for displaying by the at least one sink device the at least one corresponding virtual page, when it is determined the at least one sink device is communicatively connected to the source device.

17. The method of claim 16, further comprising:
managing the transmission of the corresponding at least one virtual page to the sink device independently from selectively generating and from selectively displaying the at least one basic page.

18. The method of claim 16, further comprising:
determining whether the at least one virtual page is changed from a corresponding previous virtual page; and
outputting corresponding update information of a changed virtual page, when it is determined that the corresponding previous virtual page has changed.

19. The method of claim 18, further comprising:
selectively transmitting the changed virtual page to the display unit of a corresponding sink device, when it is determined that the corresponding previous virtual page has changed.

20. The method of claim 16, further comprising:
generating a virtual page moving signal by the source device to change a screen displayed on the display unit of the source device; and
changing the screen of the display unit of the source device to display a virtual page corresponding to the generated virtual page moving signal.

21. The method of claim 20, wherein the virtual page moving signal corresponds to one or more of a shortcut icon displayed on the display unit of the source device and a touch event, when applied, to the display unit of the source device.

22. The method of claim 16, further comprising:
storing by the source device information to generate a corresponding virtual page transmitted by the source device to a corresponding sink device, when the corresponding sink device is communicatively disconnected from the source device.

23. The method of claim 22, further comprising:
selectively transmitting by the source device to the at least one sink device frame data corresponding to the stored information for displaying by the at least one sink device the corresponding virtual page.

24. The method of claim 16, further comprising:
selectively outputting frame data corresponding to the at least one basic page by the source device at a screen ratio of the display unit of the source device; and
selectively outputting frame data corresponding to the at least one virtual page by the source device at a screen ratio of a display unit of the corresponding at least one sink device.

25. The method of claim 16, further comprising:
selectively interlinking the at least one virtual page with a corresponding at least one sink device, when it is determined the at least one sink device is communicatively connected to the source device.

26. The method of claim 16, further comprising:
selectively transmitting to the at least one sink device, when updated, update information of a corresponding virtual page, when it is determined the at least one sink device is communicatively connected to the source device.

27. The method of claim 16, further comprising:
managing the at least one virtual page independently from the at least one basic page.
